(19) United States
(12) Patent Application Publication
(10) Pub. No.: US 2025/0388487 A1
(43) Pub. Date: Dec. 25, 2025

(54) REMOTE COMMISSIONING VALVE

(71) Applicant: Pentair, Inc., Minneapolis, MN (US)

(72) Inventor: Kenneth Seith, Delafield, WI (US)

(21) Appl. No.: 19/245,812

(22) Filed: Jun. 23, 2025

Related U.S. Application Data
(60) Provisional application No. 63/662,875, filed on Jun. 21, 2024.

(51) Int. Cl. C02F 1/00; C02F 1/42

(52) U.S. Cl. CPC C02F 1/008; C02F 1/42; C02F 2209/008; C02F 2209/40; C02F 2303/16

(57) ABSTRACT

A system and method of remotely commissioning a water softener is provided. The water softening system includes a remote device and a water softener in wireless communication with the remote device. The water softener includes a selector valve in fluid communication with an inlet port, an outlet port, a drain port, and a brine tank, a selector motor coupled to the selector valve to actuate the selector valve between a backwash configuration, a service configuration, a refill configuration, and a brine draw configuration, and a controller configured to control the selector motor based on commands from the remote device.

### CROSS-REFERENCE TO RELATED APPLICATION

This application claims priority to U.S. Provisional Patent Application No. 63/662,875, filed Jun. 21, 2024, the entire contents of which are incorporated herein by reference.

### TECHNOLOGY FIELD

This disclosure generally relates to water softening. More specifically, the disclosure relates to a remote commissioning valve used in water softening applications.

### BACKGROUND

Water softeners are often used to reduce undesirable mineral content dissolved in water. These water softeners flow water with a high concentration of undesirable minerals, often called “hard water,” over resin pellets coated in a desirable mineral (e.g., sodium). As the hard water flows over the resin pellets, the undesirable minerals are exchanged with the desirable mineral, making the water “soft.” The soft water is then supplied via plumbing for drinking, cooking, bathing, etc.

Water softeners include physical plumbing connections and electronic control components. During installation, a trained technician plumbs the water softener into an existing aquatic water system. The same trained technician also initializes, calibrates, and tests the electronic control components, often called “commissioning.” This can be a lengthy process and technicians who are both trained plumbers and trained electrical control workers may be in short supply.

As such, there is a need for an improved water softener that is designed to be commissioned remotely and that is further designed to be operated and adjusted remotely.

### SUMMARY

Some embodiments provide a method of remotely commissioning a water softener, the method including providing a water softener having a controller, an inlet valve, a resin tank, a brine tank, a selector valve, and a selector motor coupled to the selector valve to actuate the selector valve between at least one of a backwash configuration, a service configuration, or a brine draw configuration, connecting the controller to a wireless communication network, receiving a first command from a remote device to move the selector valve to the backwash configuration, receiving a second command from the remote device to open the inlet valve to a first partially open position, and receiving a third command from the remote device to open the inlet valve to a fully open position to purge air from the resin tank.

In some embodiments, the water softener further includes an outlet valve, and the method includes receiving a fourth command from the remote device to open the outlet valve. In some embodiments, the method further includes receiving the third command a predetermined interval of time after receiving the second command. In some embodiments, the predetermined interval of time is at least 15 minutes. In some embodiments, the method further includes capturing a first force value of a predetermined amount of salt added to the brine tank and verifying whether the predetermined amount of salt matches a target amount of salt. In some embodiments, the method further includes capturing a second force value of a predetermined volume of water added to the brine tank and verifying whether the predetermined volume of water matches a target volume of water.

In some embodiments, the method further includes receiving a fifth command from the remote device to activate the selector motor to advance the selector valve to the brine draw configuration and drawing brine from the brine tank into the resin tank. In some embodiments, the method further includes remaining in the brine draw configuration for at least 15 minutes after brine has been substantially emptied from the brine tank. In some embodiments, the method further includes capturing a remaining salt force value and verifying whether the remaining salt force value is less than the first force value. In some embodiments, in the service configuration, the inlet valve and an outlet valve of the water softener are in fluid communication via the resin tank, and the method further includes receiving a sixth command from the remote device to activate the selector motor to advance the selector valve to the service configuration after verifying whether the remaining salt force value is less than the first force value.

Some embodiments provide a method of remotely commissioning a water softener, the method including providing a water softener having a controller, an inlet valve, a resin tank, a brine tank, and a selector motor for actuating a selector valve, connecting the controller to a wireless communication network, receiving a first command from a remote device to move the selector valve to a backwash configuration, receiving a second command from the remote device to open the inlet valve to purge air from the resin tank, receiving a third command from the remote device to move the selector valve to a refill configuration to fill the brine tank with water, receiving a fourth command from the remote device to activate the selector motor to advance the selector valve to a brine draw configuration and drawing brine from the brine tank into the resin tank, remaining in the brine draw configuration after brine has been substantially emptied from the brine tank and rinsing the resin tank with water, and receiving a fifth command from the remote device to activate the selector motor to advance the selector valve to a service configuration.

In some embodiments, the method further includes capturing a first force value of a predetermined amount of salt added to the brine tank and verifying whether the predetermined amount of salt matches a target amount of salt before the third command is received. In some embodiments, the method further includes capturing a second force value of a predetermined volume of water added to the brine tank and verifying whether the predetermined volume of water matches a target volume of water after verifying whether the predetermined amount of salt matches a target amount of salt.

Some embodiments provide a water softening system including a remote device and a water softener in electronic communication with the remote device. The water softener includes a selector valve in fluid communication with an inlet port, an outlet port, a drain port, and a brine tank, a selector motor coupled to the selector valve to actuate the selector valve between a backwash configuration, a service configuration, a refill configuration, and a brine draw configuration, and a controller configured to control the selector motor based on commands from the remote device.

In some embodiments, the controller controls the selector valve based on data from at least one of a float sensor, a scale, the selector valve, the selector motor, a flow meter, a pressure sensor, an inlet valve, an inlet motor, an outlet valve, or an outlet motor. In some embodiments, the selector valve fluidly connects the inlet port to the outlet port via a resin tank and the inlet port to the drain port when the selector valve is in the backwash configuration. In some embodiments, the selector valve fluidly connects the inlet port to the brine tank via a resin tank when the selector valve is in the refill configuration. In some embodiments, the selector valve fluidly connects the inlet port to the drain port, and a resin tank to the drain port and the brine tank, when the selector valve is in the brine draw configuration. In some embodiments, the controller is configured to determine a volume of fluid in the brine tank using data from at least one of a float sensor or a scale. In some embodiments, the controller is configured to control the selector valve to stop filling the brine tank once a volume of fluid in the brine tank reaches a target volume.

Some embodiments provide a water softener. The water softener includes a valve and a controller having a processor and memory. The controller is configured to receive commands from a remote device to control the valve. In some instances, the water softener also includes an electromechanical device coupled to the valve to actuate the valve. In some instances, the electromechanical device is provided in the form of a motor, and the motor actuates the valve between a plurality of configurations. In some instances, the valve is provided in the form of a selector valve, and the controller controls the selector valve based on data from one or more of an optional float sensor, a scale, the selector valve, a selector motor, a flow meter, a pressure sensor, an inlet valve, an inlet motor, an outlet valve, and an outlet motor. In some instances, the controller controls the inlet valve based on data from one or more of the optional float sensor, the scale, the selector valve, the selector motor, the flow meter, the pressure sensor, the inlet valve, the inlet motor, the outlet valve, and the outlet motor.

In some embodiments, the inlet motor actuates the inlet valve. In some instances, the flow meter and the pressure sensor are coupled to the inlet valve. In some instances, the outlet motor actuates the outlet valve. In some instances, the float sensor and the scale are coupled to a brine tank. In some instances, the controller is configured to control the selector valve to stop filling the brine tank once the volume of fluid reaches a target volume.

Some embodiments provide a water softening system including a remote device and a water softener. The water softener is in wireless communication with the remote device. The water softener includes a selector valve and a controller configured to control the selector valve based on commands from the remote device. In some instances, the water softener is in wireless communication with the remote device via a cloud network.

Some instances provide a method to remotely commission a water softener including connecting a controller to a communication network, the controller including a selector valve; and positioning the selector valve selectively amongst a plurality of configurations based on instructions received via the communication network to backwash a resin tank, fill a brine tank, and draw brine from the brine tank into the resin tank.

In some instances, the method further includes determining a target water volume amount based on a dosage amount of salt.

Some embodiments provide a water softener, that includes a selector valve and a selector motor. The selector valve is in fluid communication with an inlet, an outlet, a resin tank, a brine tank, and a drain. The selector motor is in communication with a remote device and is connected to the selector valve. The selector motor is configured to actuate the selector valve based on instructions from the remote device to selectively fluidly connect the inlet, the outlet, the resin tank, the brine tank, and the drain with one another.

### BRIEF DESCRIPTION OF THE DRAWINGS

FIG. 1 illustrates a water softening system operating in accordance with the teachings of this disclosure;

FIG. 2 is a block diagram of the water softening system of FIG. 1;

FIG. 3 is a block diagram of fluid transfer components of the water softening system of FIG. 1 arranged in a backwash configuration;

FIG. 4 is a block diagram of the fluid transfer components of FIG. 3 arranged in a brine draw configuration;

FIG. 5 is a block diagram of the fluid transfer components of FIG. 3 arranged in a refill or regeneration configuration;

FIG. 6 is a block diagram of the fluid transfer components of FIG. 3 arranged in a service configuration;

FIG. 7 is a first portion of a flowchart representative of a method of operating the water softening system of FIG. 1;

FIG. 8 is a second portion of the flowchart of FIG. 7; and

FIG. 9 is a third portion of the flowchart of FIGS. 7 and 8.

### DETAILED DESCRIPTION

Various modifications to the illustrated embodiments will be readily apparent to those skilled in the art, and the generic principles herein can be applied to other embodiments and applications. Thus, it is to be understood that the disclosure is not limited in its application to the details of the configuration and arrangement of components set forth in the following description or illustrated in the accompanying drawings. The disclosure is capable of being practiced or conducted in various ways and is to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the disclosure. Skilled artisans will recognize the examples provided herein have many useful alternatives and fall within the scope of the disclosure.

Before any embodiments are explained in further detail, it is to be understood that the disclosure is not limited in its application to the details of construction and the arrangement of components set forth in the following description or illustrated in the attached drawings. The disclosure is capable of other embodiments and of being practiced or of being conducted in various ways. Also, it is to be understood that the phraseology and terminology used herein are for the purpose of description and should not be regarded as limiting. For example, the use of “including,” “comprising,” or “having” and variations thereof herein is meant to encompass the items listed thereafter and equivalents thereof as well as additional items.

As used herein, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

As used herein, unless otherwise specified or limited, “at least one of A, B, and C,” and similar other phrases, are meant to indicate A, or B, or C, or any combination of A, B, or C. As such, this phrase, and similar other phrases can include single or multiple instances of A, B, or C, and, in the case that any of A, B, or C indicates a category of elements, single or multiple instances of any of the elements of the categories A, B, or C.

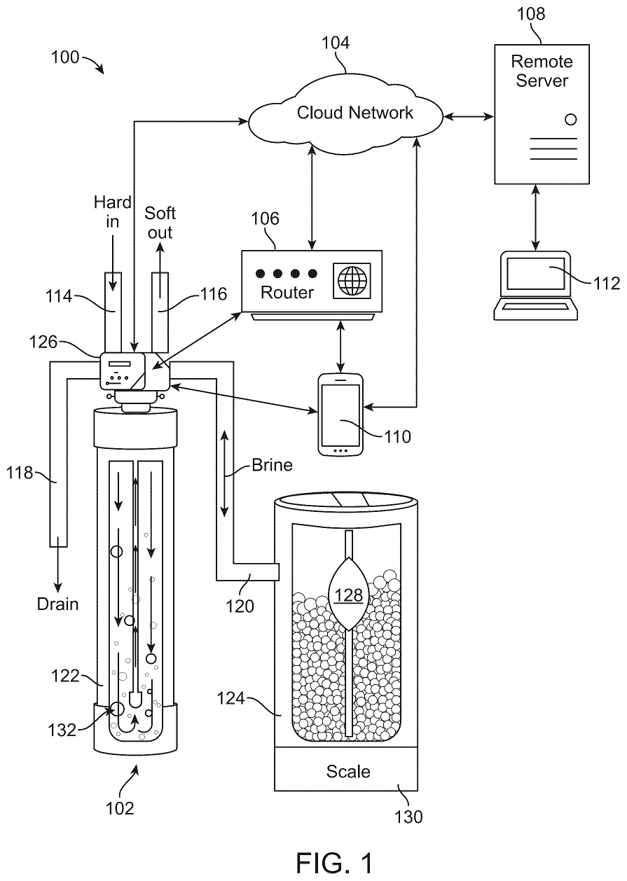

FIG. 1 illustrates a water softening system 100 in accordance with the teachings of this disclosure. Once the physical connections of the water softening system 100 are made and salt is supplied, the water softening system 100 is adapted to be remotely, electronically calibrated and prepared for service, often referred to as “commissioning.”

As shown in FIG. 1 the water softening system 100 includes a water softener 102 in communication with a cloud network 104, a wireless router 106, a remote server 108, a mobile device 110, and a computing device 112. The water softener 102 is designed to send and receive data over one or more components of the cloud network 104. In some instances, the water softener 102 is in communication with the mobile device 110. In some instances, the water softener 102 is in communication with the cloud network 104 directly. The cloud network 104 is further in communication with the wireless router 106, the remote server 108, and the mobile device 110. In some instances, the mobile device 110 is in communication with the wireless router 106. The computing device 112 is in communication with the remote server 108.

In some instances, the water softener 102 is in communication with the cloud network 104 via a wireless communication network. Accordingly, the water softener may use wireless network protocols such as Wi-Fi (e.g., an 802.11x network, which can include one or more wireless routers, one or more switches, etc.), peer-to-peer (e.g., a Bluetooth network, a ZigBee® network, a Z-Wave® network, a proprietary RF connection, etc.), or cellular (e.g., a 3G network, a 4G network, etc., complying with any suitable standard, such as CDMA, GSM, LTE, LTE Advanced, WiMAX, etc.). In some embodiments, the communication network can be a LAN, a WAN, a public network (e.g., the Internet), a private or semi-private network (e.g., a corporate or university intranet), any other suitable type of network, or any suitable combination of networks.

When the water softener 102 is initially installed, one or more technicians may remotely, electronically access, calibrate, and prepare the water softener 102 for service via one or more of the cloud network 104, the wireless router 106, the remote server 108, the mobile device 110, and the computing device 112. Thus, the water softener 102 can be remotely commissioned, as will be explained in further detail below. Additionally, the operation of the water softener 102 can be monitored and adjusted (e.g., remotely) during the life of the water softener 102.

The water softener 102 is in fluid communication with a supply line 114 that provides hard water and an output line 116 that provides softened water. The water softener 102 includes a drain line 118, a brine line 120, a resin tank 122, a brine tank 124, a softener mode selector or controller 126, an optional float sensor 128, and a scale 130. The resin tank 122 is in fluid communication with the brine tank 124 via the brine line 120, the resin tank 122 contains a plurality of polymeric beads 132, and the float sensor 128 is positioned inside the brine tank 124. In one instance, the float sensor 128 is provided in the form of an overflow valve in the brine line 120 to prevent the tank from refilling when the tank is full.

Referring still to FIG. 1, in day-to-day operation after commissioning, the brine tank 124 is filled with hard water from the supply line 114 and salt (sodium chloride) to produce a brine. The brine is transferred to the resin tank 122 where positively charged sodium ions from the brine coat the polymer beads 132, which are negatively charged. Once the polymer beads 132 are saturated with sodium, excess brine is rinsed out of the resin tank 122 via the drain line 118 using water provided by the supply line 114. Water from the supply line 114 is “hard,” meaning the water includes undesirable dissolved minerals (e.g., calcium, magnesium, sulfates, etc.). Further in operation, hard water from the supply line 114 fills and passes through the resin tank 122. The water exits the resin tank 122 via the output line 116. As the initially hard water passes over the sodium ion-coated polymer beads 132, the undesirable dissolved minerals are exchanged with the sodium ions. Thus, the undesirable dissolved minerals are captured by the polymer beads 132 and the sodium ions are released into solution in the water, making the water exiting the resin tank 122 “soft.” It should be appreciated that the concentration of sodium in the soft water is generally undetectable to humans and animals. Thus, the soft water is fresh and potable. When the polymer beads 132 have been exhausted of sodium ions, a regeneration is initiated and begins with backwash, then proceeds to the brine draw, where brine is drawn from the brine tank 124, and the brine is transferred to the resin tank 122. In the resin tank 122, the brine removes the captured undesirable minerals and the polymer beads 132 are recharged with sodium ions. Once the brine is rinsed from the resin tank 122, the water softener 102 is again ready to produce soft water. Thus, the water softener 102 repeatedly cycles through softening, regeneration, backwashing, and rinse modes or cycles. In one instance, the water softener 102 can have five cycles, such as the backwash, brine draw (e.g., slow rinse), fast rinse, refill, and/or service. In other instances, the water softener 102 can have seven cycles.

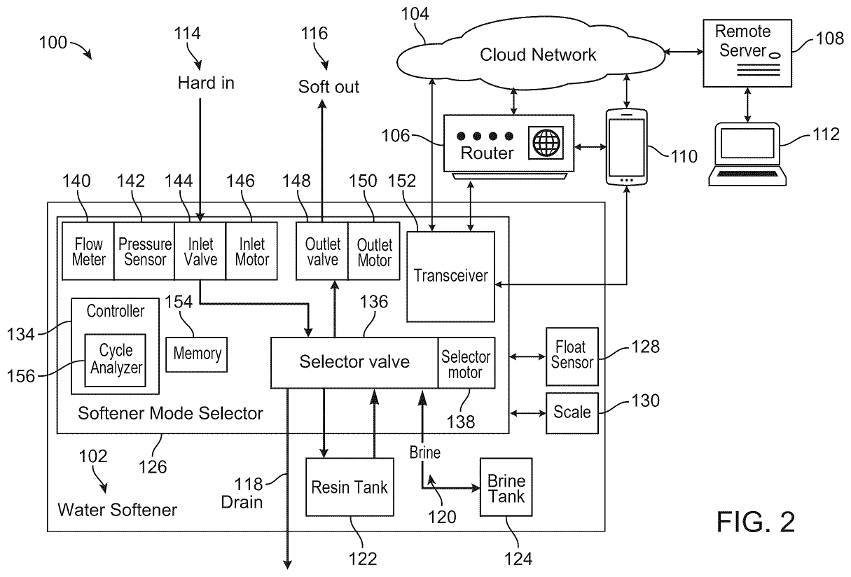

FIG. 2 further illustrates various components of the water softening system 100. The softener mode selector 126 further includes a processor or controller 134, a selector valve 136, a selector motor 138, a flow meter 140, a pressure sensor 142, an inlet valve 144, an inlet motor or an electromechanical device (e.g., a solenoid) 146, an outlet valve 148, an outlet motor or an electromechanical device (e.g., a solenoid) 150, a transceiver 152, and a memory 154. The controller 134 includes a cycle analyzer 156, which includes instructions to control and collect data from one or more of the float sensor 128, the scale 130, the selector valve 136, the selector motor 138, the flow meter 140, the pressure sensor 142, the inlet valve 144, the inlet motor 146, the outlet valve 148, the outlet motor 150, the transceiver 152, or the memory 154.

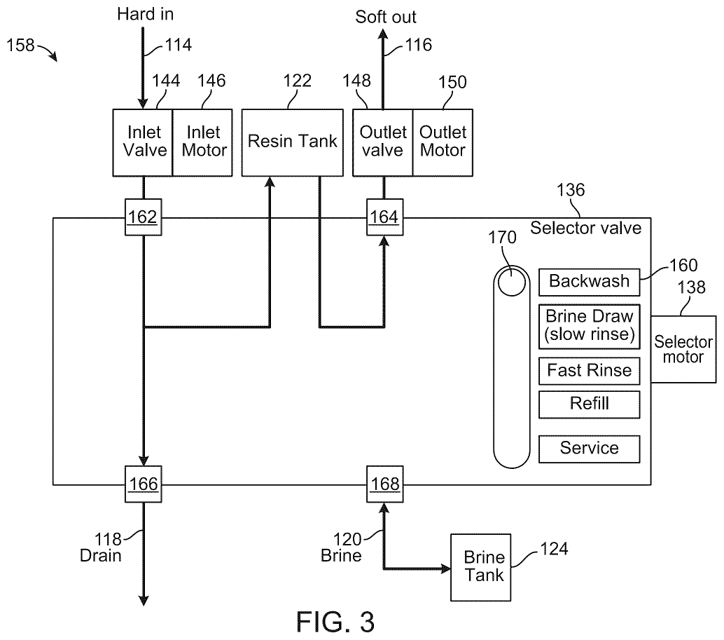

Referring still to FIG. 2, the selector valve 136 is in selective fluid communication with the drain line 118, the resin tank 122, the brine tank 124, the inlet valve 144, and the outlet valve 148. The selector motor 138 actuates the selector valve 136 between various water softening cycle modes, as will be explained in conjunction with FIGS. 3-6. When the selector valve 136 is actuated between the water softening modes, the selector valve 136 selectively places the drain line 118, the resin tank 122, the brine tank 124, the inlet valve 144, and the outlet valve 148 in fluid communication with one another.

The flow meter 140 is designed to measure a flow rate of water moving through the inlet valve 144. The pressure sensor 142 can be designed to measure a pressure of the water moving through the inlet valve 144. Further, the inlet motor 146 actuates the inlet valve 144 from a fully closed position to a fully open position, or the inlet motor 146 may actuate the inlet valve 144 to any partially open position between the fully closed position and the fully open position. Similarly, the outlet motor 150 actuates the outlet valve 148 from a fully closed position to a fully open position, or the outlet motor 150 may actuate the outlet valve 148 to any partially open position between the fully closed position and the fully open position.

The softener mode selector 126 is in communication with one or more of the cloud network 104, the wireless router 106, and the mobile device 110 via the transceiver 152. Thus, a remote technician may electronically access and control the softener mode selector 126 via one or more of the mobile device 110 or the computing device 112. More specifically, the remote technician may connect to the cycle analyzer 156 to selectively actuate the selector valve 136, the inlet valve 144, and the outlet valve 148 via the selector motor 138, the inlet motor 146, and the outlet motor 150, respectively. Additionally, the remote technician may connect to the controller 134 to capture data from one or more of the float sensor 128, the scale 130, the flow meter 140, and/or the pressure sensor 142.

Referring still to FIG. 2, the controller 134 may be provided in the form of any suitable processing device or set of processing devices such as, but not limited to a microprocessor, a microcontroller-based platform, a suitable integrated circuit, one or more field programmable gate arrays (FPGAs), and/or one or more application-specific integrated circuits (ASICs). The memory 154 may be provided in the form of volatile memory (e.g., RAM, which may include magnetic RAM, ferroelectric RAM, and any other suitable forms), non-volatile memory (e.g., disk memory, FLASH memory, EPROMs, EEPROMs, non-volatile solid-state memory, etc.), unalterable memory (e.g., EPROMs), read-only memory, and/or high-capacity storage devices (e.g., hard drives, solid state drives, etc.). In some examples, the memory 154 includes multiple types of memory, particularly both volatile memory and non-volatile memory.

FIG. 3 illustrates fluid transfer components 158 of the water softening system 100 of FIGS. 1 and 2 arranged in a backwash operation or configuration 160. The selector valve 136 includes an inlet port 162, an outlet port 164, a drain port 166, and a brine port 168. In some instances, the selector valve 136 also includes an indicator 170 that depicts the selected water softening mode configuration (e.g., the backwash configuration 160). In operation, the selector motor 138 may be actuated (e.g., by a remote technician) to place the selector valve 136 in the backwash configuration 160. When the selector valve 136 is in the backwash configuration 160, the outlet port 164 is in fluid communication with the inlet port 162 and the drain port 166 via the resin tank 122. Additionally, in the backwash configuration 160, the inlet port 162 is in fluid communication with the drain port 166. It should be appreciated that fluid communication between the supply line 114 and the inlet port 162 depends on whether the inlet valve 144 is open. Similarly, fluid communication between the output line 116 and the outlet port 164 depends on whether the outlet valve 148 is open. Thus, in some instances, with the inlet valve 144 open, the outlet valve 148 closed, and the selector valve 136 in the backwash configuration 160, the resin tank 122 may be filled with water provided by the supply line 114 while air in the resin tank 122 is vented out of the resin tank 122 via the drain port 166 and the drain line 118. In such instances, the vented air is prevented from entering the output line 116.

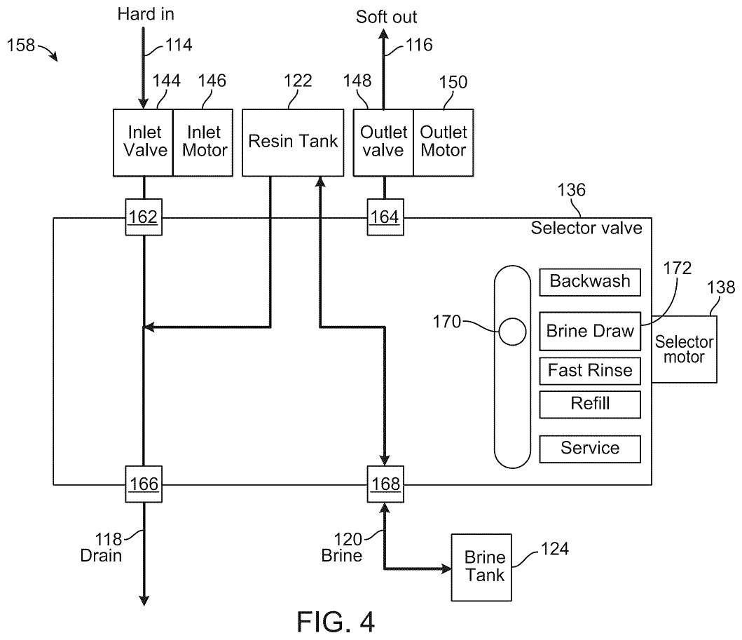

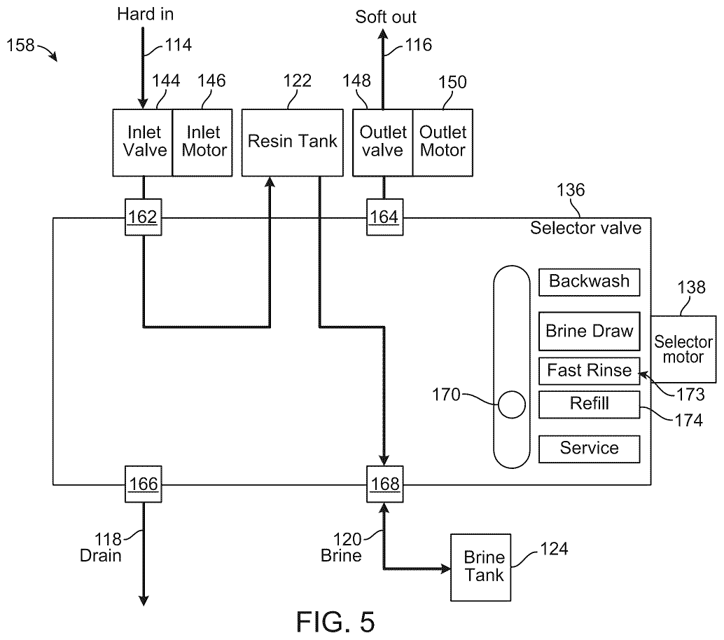

FIG. 4 illustrates the fluid transfer components 158 arranged in a brine draw operation 172. In operation, the selector motor 138 may be actuated (e.g., by a remote technician) to place the selector valve 136 in the brine draw configuration 172. When the selector valve 136 is in the brine draw configuration 172, the brine port 168 is in fluid communication with the inlet port 162 and the drain port 166 via the resin tank 122. Additionally, in the brine draw configuration 172, the inlet port 162 is in fluid communication with the drain port 166. Thus, with the selector valve 136 in the brine draw configuration 172, brine provided by the brine line 120 from the brine tank 124 may fill the resin tank 122 to remove undesirable dissolved minerals from the polymer beads 132 (shown in FIG. 1) and recoat the polymer beads 132 with sodium ions. Further, once the polymer beads 132 are recoated with sodium ions, with the inlet valve 144 open and the selector valve 136 in the brine draw configuration 172, water provided by the supply line 114 may rinse (e.g., a slow rinse and/or (e.g., followed) by a fast rinse 173, shown in FIG. 5) the resin tank 122 to excess brine and the undesirable dissolved minerals.

FIG. 5 illustrates the fluid transfer components 158 arranged in a refill operation 174. In operation, the selector motor 138 may be actuated (e.g., by a remote technician) to place the selector valve 136 in the refill configuration 174. When the selector valve 136 is in the refill configuration 174, the inlet port 162 is in fluid communication with the brine port 168 via the resin tank 122. Thus, with the inlet valve 144 open and the selector valve 136 in the refill configuration 174, water provided by the supply line 114 may pass through the resin tank 122 to refill the brine tank 124.

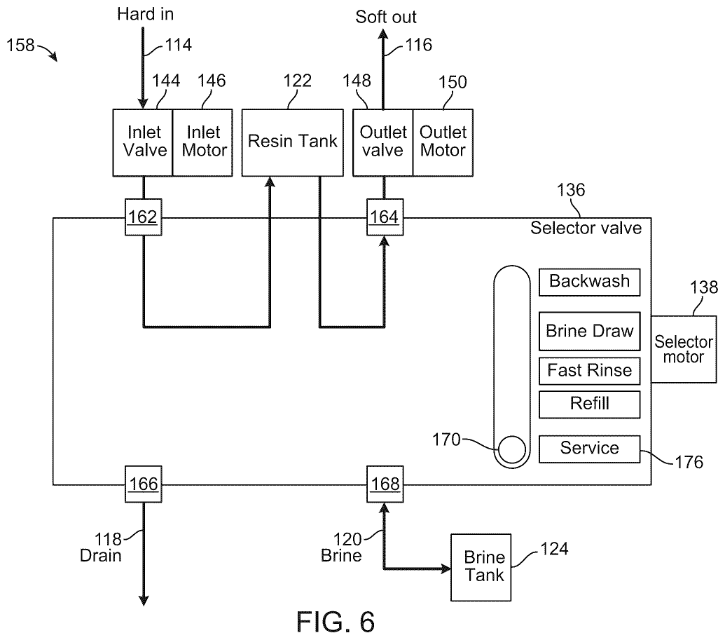

FIG. 6 illustrates the fluid transfer components 158 arranged in a service operation 176. In operation, the selector motor 138 may be actuated (e.g., by a remote technician) to place the selector valve 136 in the service configuration 176. When the selector valve 136 is in the service configuration 176, the inlet port 162 is in fluid communication with the outlet port 164 via the resin tank 122. Thus, in some instances, with the inlet valve 144 open, the outlet valve 148 open, and the selector valve 136 in the service configuration 176, water provided by the supply line 114 may pass through the resin tank 122 and be softened by the sodium ion-coated polymer beads 132 (shown in FIG. 1). Additionally, in the service configuration 176, the softened water exits the resin tank 122 via the outlet port 164, the outlet valve 148, and the output line 116.

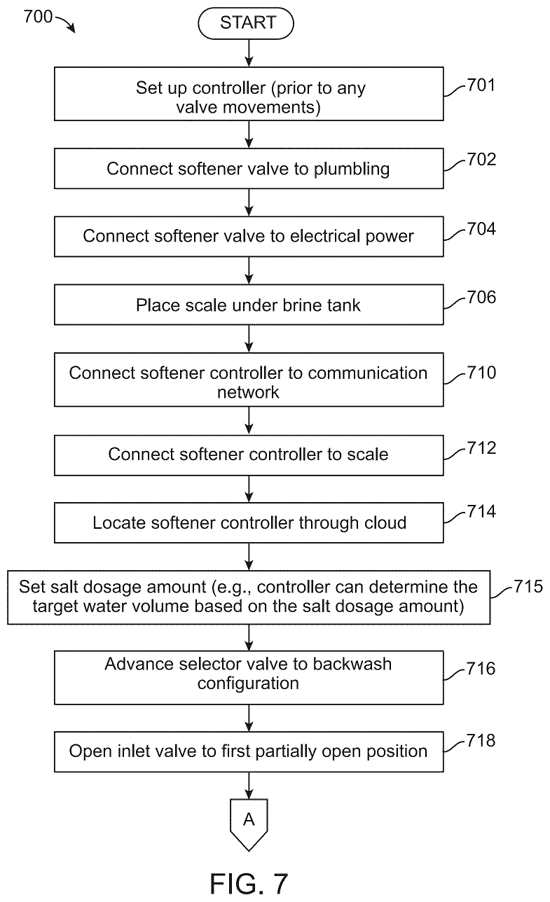

A flowchart representative of an example method 700 to install the water softener 102 of FIG. 1 and remotely commission the water softener 102 is shown in FIGS. 7, 8, and 9. For example, the order of execution of the steps may be changed, and/or some of the steps described may be changed, eliminated, or combined.

The method 700 of the illustrated example of FIGS. 7, 8, and 9 begins at step 701 where the controller 134 is set up (e.g., prior to any valve movement). The method 700 then proceeds to step 702 where a softener valve 126 (e.g., softener mode selector) of FIG. 1 is connected to plumbing, specifically the supply line 114, the output line 116, the drain line 118, and the brine line 120.

At step 704, the softener valve or softener mode selector 126 is connected to electrical power.

At step 706, the scale 130 is placed under or is otherwise in communication with the brine tank 124 (see FIG. 1).

At step 710, the softener mode selector 126 is connected to at least one of the wireless router 106 or the cloud network 104.

At step 712, the softener mode selector 126 is connected to the scale 130.

At step 714, the softener mode selector 126 is located through the cloud network 104 via the mobile device 110 and/or the computing device 112.

At step 715, an amount of salt (e.g., a predetermined amount or dosage) can be set for addition to the brine tank 124. Further, the controller 134, based on the salt dosage amount, can determine the target water volume for creating the brine.

At step 716, the controller 134 receives a first command from the computing device 112 via the cloud network 104 and/or the mobile device 110 to activate the selector motor 138 to advance the selector valve 136 to the backwash configuration 160.

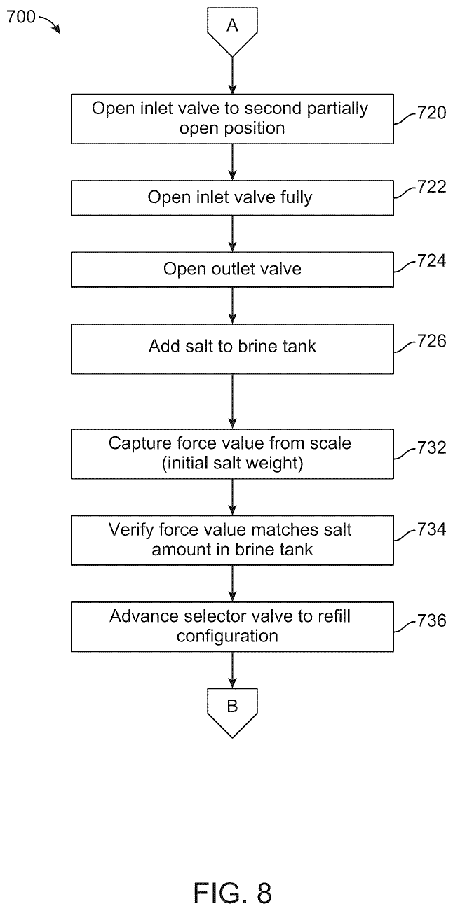

At step 718, the controller 134 receives a second command from the computing device 112 via the cloud network 104 and/or the mobile device 110 to activate the inlet motor 146 to open the inlet valve 144 to a first partially open position. Thus, water flows through the resin tank 122 and to the drain line 118. This purges air in the softener mode selector 126 and the resin tank 122 to the drain line 118 rather than pushing air into the output line 116. The method 700 proceeds to FIG. 8 via linking block A.

With reference to FIG. 8, the method 700 continues from linking block A to step 720, where the controller 134 receives a third command from the computing device 112 via the cloud network 104 and/or the mobile device 110 to activate the inlet motor 146 to open the inlet valve 144 to a second partially open position. The second partially open position is more open than the first partially open position (e.g., the second allows more fluid flow therethrough). In some instances, the third command is sent after a predetermined period of time, such as approximately 15 minutes after the second command of step 718.

At step 722, the controller 134 receives a fourth command from the computing device 112 via the cloud network 104 and/or the mobile device 110 to activate the inlet motor 146 to fully open the inlet valve 144. In some instances, the fourth command is sent after a predetermined period of time, such as approximately 10 minutes after the third command of step 720. It should be appreciated that the inlet valve 144 is progressively or selectively opened by the inlet motor 146 to gradually fill the resin tank 122 with water to purge air from the resin tank 122 and the softener mode selector 126.

At step 724, the controller 134 receives a fifth command from the computing device 112 via the cloud network 104 and/or the mobile device 110 to activate the outlet motor 150 to fully open the outlet valve 148.

At step 726, the controller 134 receives a sixth command from the computing device 112 via the cloud network 104 and/or the mobile device 110 to activate the selector motor 138 to add salt to the brine tank.

At step 732, the controller 134 receives a seventh command from the computing device 112 via the cloud network 104 and/or the mobile device 110 to capture an initial force value from the scale 130. Since the brine tank 124 only contains salt at this point, the initial force value corresponds to the weight of the predetermined amount of salt, or the initial salt weight, added to the brine tank 124 in step 715.

At step 734, the controller 134 receives an eighth command from the computing device 112 via the cloud network 104 and/or the mobile device 110 to verify that the initial force value measured by the scale 130 matches the expected force value of the predetermined amount of salt added to the brine tank 124 in step 715.

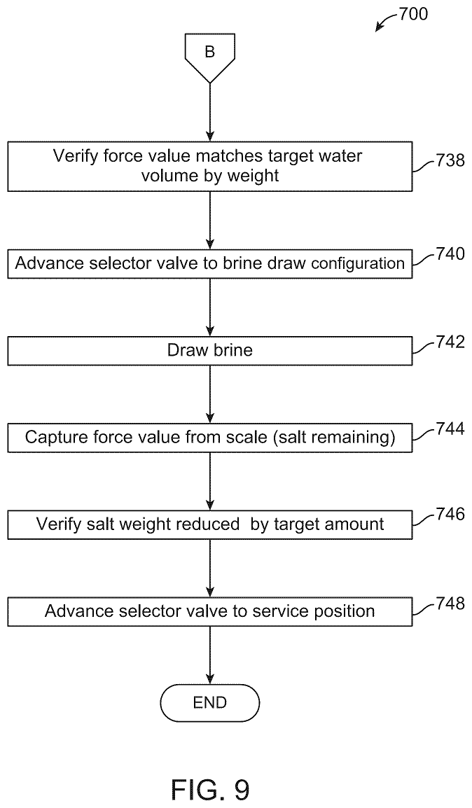

At step 736, the controller 134 receives a ninth command from the computing device 112 via the cloud network 104 and/or the mobile device 110 to actuate the selector motor 138 to advance the selector valve 136 to the refill configuration 174. This begins flowing water to the brine tank 124. The method 700 proceeds to FIG. 9 via linking block B.

With reference to FIG. 9, the method 700 continues from linking block B to step 738, where the controller 134 receives a tenth command from the computing device 112 via the cloud network 104 and/or the mobile device 110 to verify that the mixed brine force value measured by the scale 130 matches the combined target weight of the water volume and the weight of the predetermined amount of salt. In some instances, the controller 134 determines the water volume based on a position of the float sensor 128 or the overflow valve in the brine tank 124. In some instances, the controller 134 determines the water volume based on a pressure value from the pressure sensor 142, an orifice area of the inlet valve 144, and an elapsed time that the inlet valve 144 is open. In some instances, the controller 134 determines the water volume based on flow volume values from the flow meter 140.

At step 740, the controller 134 receives an eleventh command from the computing device 112 via the cloud network 104 and/or the mobile device 110 to activate the selector motor 138 to advance the selector valve 136 to the brine draw configuration 172. In some instances, the eleventh command is sent approximately 30 minutes after the command of step 738. This delay permits the salt in the brine tank 124 to fully dissolve into the water.

At step 742, the controller 134 receives a twelfth command from the computing device 112 via the cloud network 104 and/or the mobile device 110 to draw brine from the brine tank 124 into the resin tank 122. Once the brine is completely drawn from the brine tank 124, the selector valve 136 remains in the brine draw configuration 172 position for an extended period (e.g., from about 15 minutes to about 30 minutes), during which water from the supply line 114 continues to flow through the resin tank 122. This can provide a slow rinse through the polymer beads 132.

At step 744, the controller 134 receives a thirteenth command from the computing device 112 via the cloud network 104 and/or the mobile device 110 to capture a remaining salt force value from the scale 130. The remaining salt force value indicates the amount of salt remaining in the brine tank 124.

At step 746, the controller 134 receives a fourteenth command from the computing device 112 via the cloud network 104 and/or the mobile device 110 to verify that the remaining salt force value is less than the initial force value of step 732. Thus, the controller determines that the amount of salt in the brine tank 124 has been reduced (e.g., by the target amount).

At step 748, the controller 134 receives a fifteenth command from the computing device 112 via the cloud network 104 and/or the mobile device 110 to activate the selector motor 138 to advance the selector valve 136 to the service configuration 176.

Specific embodiments of improved water softeners according to the present invention have been described for the purpose of illustrating the manner in which the invention can be made and used. It should be understood that the implementation of other variations and modifications of this invention and its different aspects will be apparent to one skilled in the art, and that this invention is not limited by the specific embodiments described. Features described in one embodiment can be implemented in other embodiments. The subject disclosure is understood to encompass the present invention and any and all modifications, variations, or equivalents that fall within the spirit and scope of the basic underlying principles disclosed and claimed herein.

What is claimed is:

1. A method of remotely commissioning a water softener, the method comprising:
providing a water softener having a controller, an inlet valve, a resin tank, a brine tank, a selector valve, and a selector motor coupled to the selector valve to actuate the selector valve between at least one of a backwash configuration, a service configuration, or a brine draw configuration;
connecting the controller to a wireless communication network;
receiving a first command from a remote device to move the selector valve to the backwash configuration;
receiving a second command from the remote device to open the inlet valve to a first partially open position; and
receiving a third command from the remote device to open the inlet valve to a fully open position to purge air from the resin tank.

2. The method of claim 1, wherein the water softener further comprises an outlet valve, and the method includes receiving a fourth command from the remote device to open the outlet valve.

3. The method of claim 1, further comprising receiving the third command a predetermined interval of time after receiving the second command.

4. The method of claim 3, wherein the predetermined interval of time is at least 15 minutes.

5. The method of claim 1, further comprising capturing a first force value of a predetermined amount of salt added to the brine tank and verifying whether the predetermined amount of salt matches a target amount of salt.

6. The method of claim 1, further comprising capturing a second force value of a predetermined volume of water added to the brine tank and verifying whether the predetermined volume of water matches a target volume of water.

7. The method of claim 5, further comprising receiving a fifth command from the remote device to activate the selector motor to advance the selector valve to the brine draw configuration and drawing brine from the brine tank into the resin tank.

8. The method of claim 7, further comprising remaining in the brine draw configuration for at least 15 minutes after brine has been substantially emptied from the brine tank.

9. The method of claim 7, further comprising capturing a remaining salt force value and verifying whether the remaining salt force value is less than the first force value.

10. The method of claim 9, wherein in the service configuration, the inlet valve and an outlet valve of the water softener are in fluid communication via the resin tank, and the method further includes receiving a sixth command from the remote device to activate the selector motor to advance the selector valve to the service configuration after verifying whether the remaining salt force value is less than the first force value.

11. A method of remotely commissioning a water softener, the method comprising:
providing a water softener having a controller, an inlet valve, a resin tank, a brine tank, and a selector motor for actuating a selector valve;
connecting the controller to a wireless communication network;
receiving a first command from a remote device to move the selector valve to a backwash configuration;
receiving a second command from the remote device to open the inlet valve to purge air from the resin tank;
receiving a third command from the remote device to move the selector valve to a refill configuration to fill the brine tank with water;
receiving a fourth command from the remote device to activate the selector motor to advance the selector valve to a brine draw configuration and drawing brine from the brine tank into the resin tank;
remaining in the brine draw configuration after brine has been substantially emptied from the brine tank and rinsing the resin tank with water; and
receiving a fifth command from the remote device to activate the selector motor to advance the selector valve to a service configuration.

12. The method of claim 11, further comprising capturing a first force value of a predetermined amount of salt added to the brine tank and verifying whether the predetermined amount of salt matches a target amount of salt before the third command is received.

13. The method of claim 12, further comprising capturing a second force value of a predetermined volume of water added to the brine tank and verifying whether the predetermined volume of water matches a target volume of water after verifying whether the predetermined amount of salt matches a target amount of salt.

14. A water softening system, comprising:
a remote device; and
a water softener in wireless communication with the remote device, the water softener including:
a selector valve in fluid communication with an inlet port, an outlet port, a drain port, and a brine tank,
a selector motor coupled to the selector valve to actuate the selector valve between a backwash configuration, a service configuration, a refill configuration, and a brine draw configuration, and
a controller configured to control the selector motor based on commands from the remote device.

15. The water softening system of claim 14, wherein the controller controls the selector valve based on data from at least one of a float sensor, a scale, the selector valve, the selector motor, a flow meter, a pressure sensor, an inlet valve, an inlet motor, an outlet valve, or an outlet motor.

16. The water softening system of claim 14, wherein the selector valve fluidly connects the inlet port to the outlet port via a resin tank and the inlet port to the drain port when the selector valve is in the backwash configuration.

17. The water softening system of claim 14, wherein the selector valve fluidly connects the inlet port to the brine tank via a resin tank when the selector valve is in the refill configuration.

18. The water softening system of claim 14, wherein the selector valve fluidly connects the inlet port to the drain port, and a resin tank to the drain port and the brine tank, when the selector valve is in the brine draw configuration.

19. The water softening system of claim 14, wherein the controller is configured to determine a volume of fluid in the brine tank using data from at least one of a float sensor or a scale.

20. The water softening system of claim 19, wherein the controller is configured to control the selector valve to stop filling the brine tank once a volume of fluid in the brine tank reaches a target volume.
